(19) United States
(12) Patent Application Publication
(10) Pub. No.: US 2025/0296381 A1
(43) Pub. Date: Sep. 25, 2025

(54) String Art Pattern Creation Device and Method

(71) Applicant: Adam Douthie, Waverly (AU)

(72) Inventor: Adam Douthie, Waverly (AU)

(21) Appl. No.: 18/610,517

(22) Filed: Mar. 20, 2024

(51) Int. Cl. B44C 3/12

(52) U.S. Cl. CPC B44C 3/12

(57) ABSTRACT

A string art pattern creation device and method for positioning nails in a frame to form a pattern for a string art design includes a frame. A guide board is positionable over the frame. A plurality of apertures extend through the guide board. A guide nail extends through a punch board to facilitate a user in forming a plurality of guide holes in the frame. The guide nail is positionable through each aperture of the plurality of apertures facilitate the user in aligning the plurality of guide holes in the frame. A plurality of nails is insertable into the frame to define a pattern for a string art design. The plurality of guide holes facilitates the user in positioning the plurality of nails centrally within the plurality of apertures extending through the guide board to facilitate the user in inserting the plurality of nails perpendicularly into the frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to string art kits and more particularly pertains to a new string art kit for positioning nails in a frame to form a pattern for a string art design.

### (2) Description of Related Art Including Information Disclosed Under 37 CFR 1.97 and 1.98.

The prior art relates to string art kits. String art generally consists of inserting a plurality of nails into a frame, then wrapping string around the nails to form a design. The process requires attention to detail, because the artist must position each nail carefully into the frame. Generally, the nails need to be aligned along the sides of the frame, with each nail be equidistantly spaced from the neighboring nails. To achieve this, the user must carefully measure out where each nail should be placed before hammering each nail into the frame. Thus, there is a need for a device that can facilitate the user in aligning the nails along the frame at equidistantly spaced positions. The nails also generally need to be hammered into the frame to uniform height. This can be difficult for the user to achieve when the user is hammering a large number of nails into the frame individually. Thus, there is a need in the art for a device that facilitates the user in hammering numerous nails into the frame to a uniform height.

### BRIEF SUMMARY OF THE INVENTION

An embodiment of the disclosure meets the needs presented above by generally comprising a frame. A guide board is positionable over the frame. A plurality of apertures extend through the guide board. The embodiment further includes a punch board. A guide nail extends through the punch board wherein the guide nail is configured to facilitate a user in forming a plurality of guide holes in the frame. The guide nail is positionable through each aperture of the plurality of apertures wherein the plurality of apertures is configured to facilitate the user in aligning the plurality of guide holes in the frame when the guide board is positioned over the frame and when the punch board is positioned over the guide board. A plurality of nails is insertable into the frame to define a pattern for a string art design, the plurality of guide holes being configured to facilitate the user in positioning the plurality of nails centrally within the plurality of apertures extending through the guide board wherein the plurality of guide holes is configured to facilitate the user in inserting the plurality of nails perpendicularly into the frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a string art pattern creation device and method according to an embodiment of the disclosure.

FIG. 2 is a top view of an embodiment of the disclosure.

FIG. 3 is a cross-sectional side view of an embodiment of the disclosure.

FIG. 4 is a front view of an embodiment of the disclosure.

FIG. 5 is an in-use side view of an embodiment of the disclosure.

FIG. 6 is an in-use side view of an embodiment of the disclosure.

FIG. 7 is an in-use side view of an embodiment of the disclosure.

FIG. 8 is an in-use view of an embodiment of the disclosure.

FIG. 9 is a top view of an embodiment of the disclosure.

FIG. 10 is an in-use view of an embodiment of the disclosure.

FIG. 11 is an in-use view of an embodiment of the disclosure.

### DETAILED DESCRIPTION OF THE INVENTION

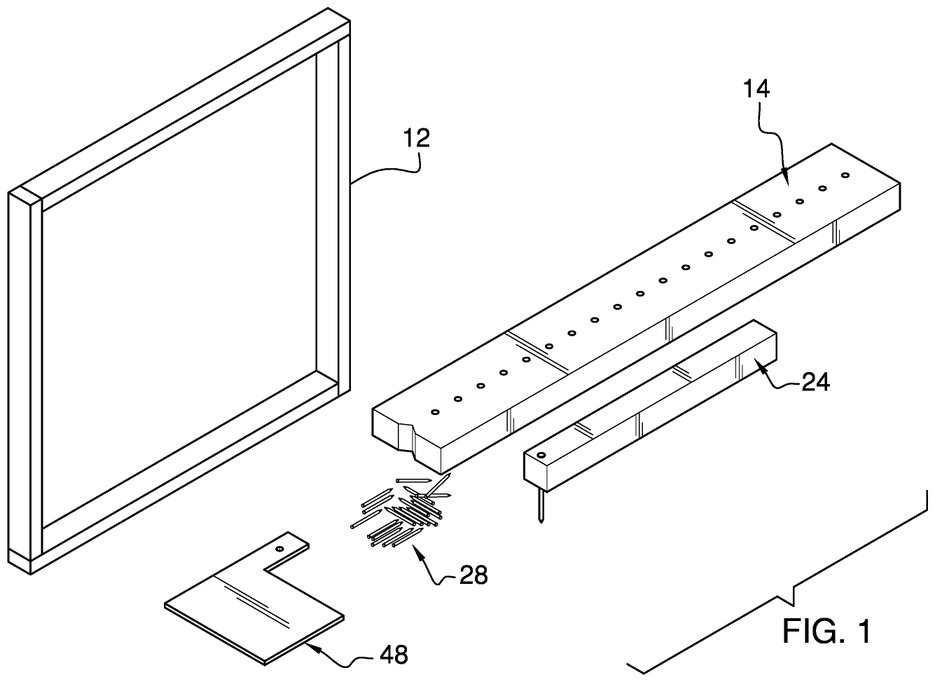

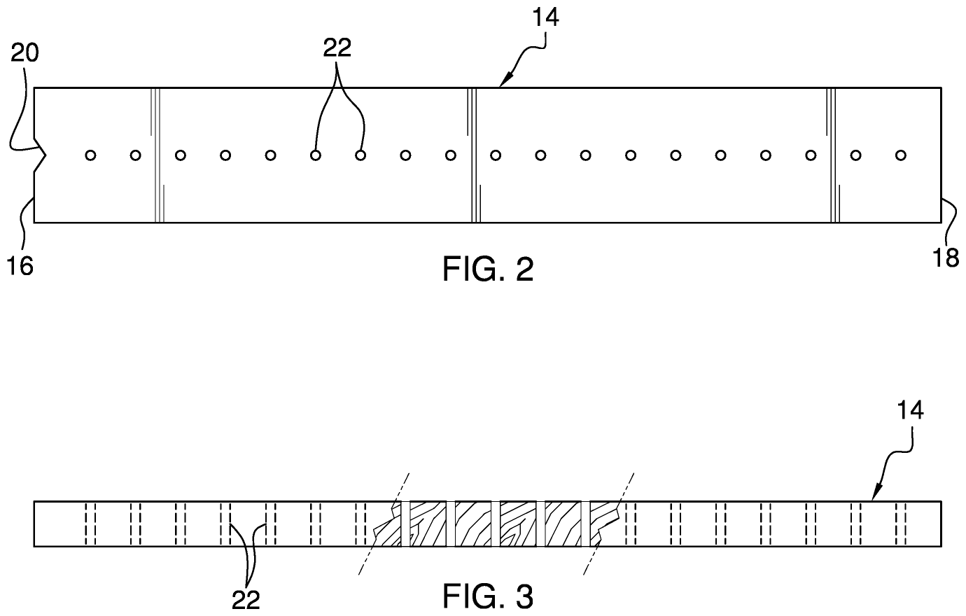

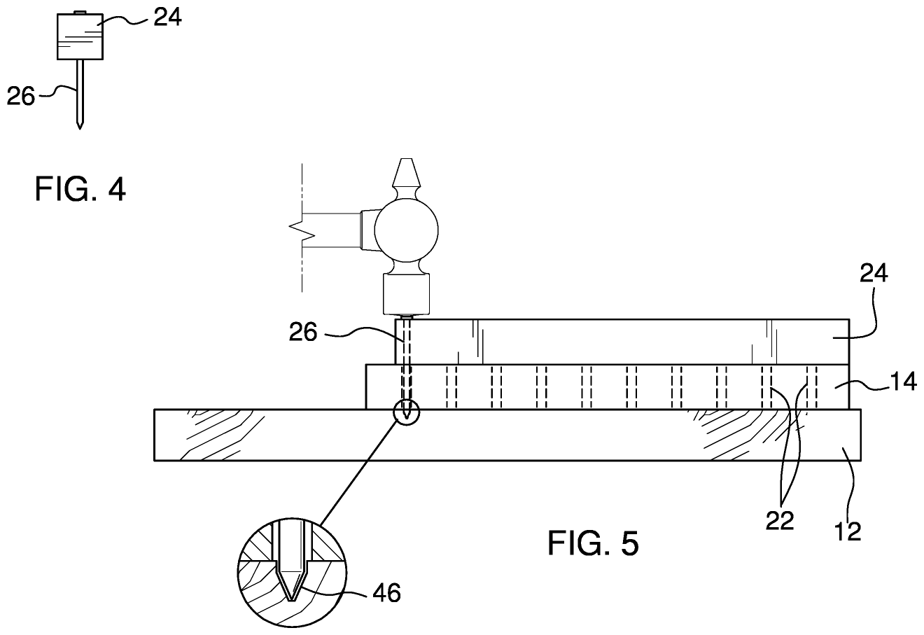

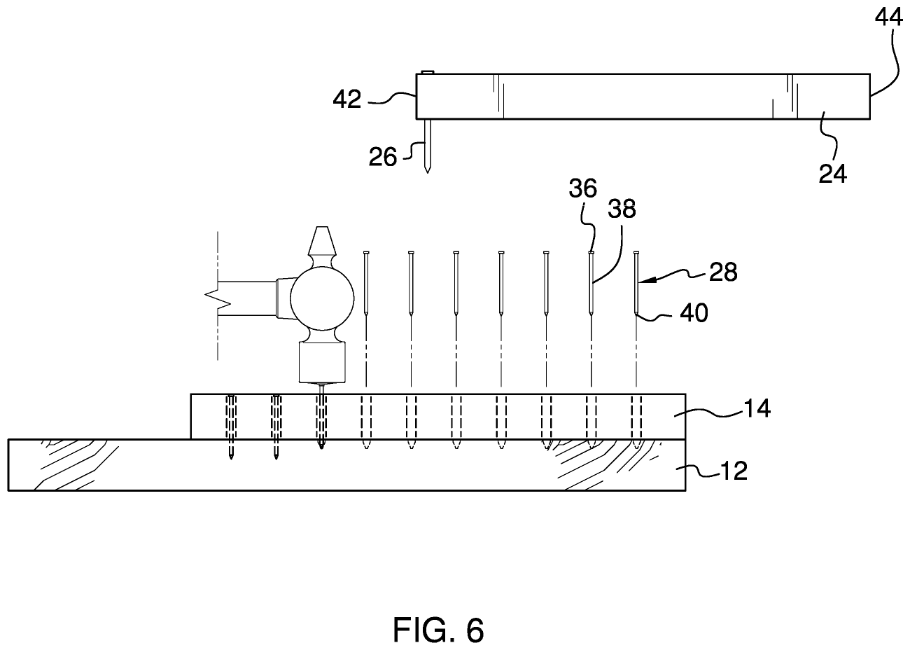

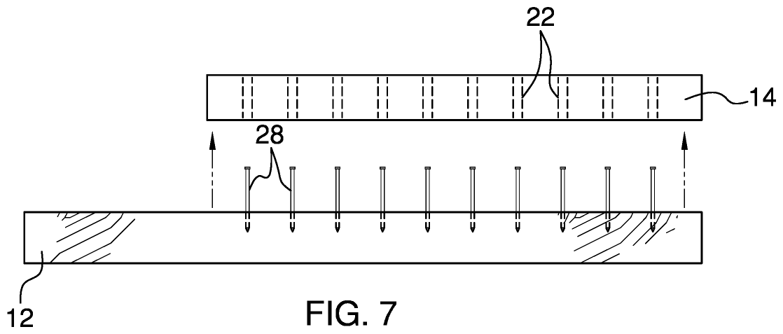

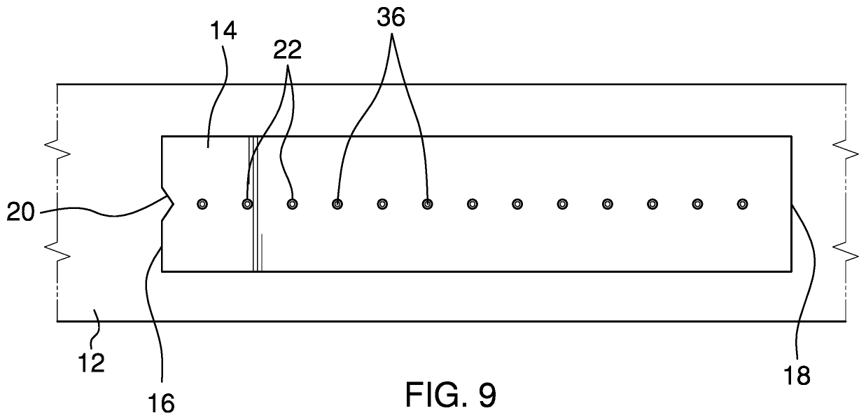

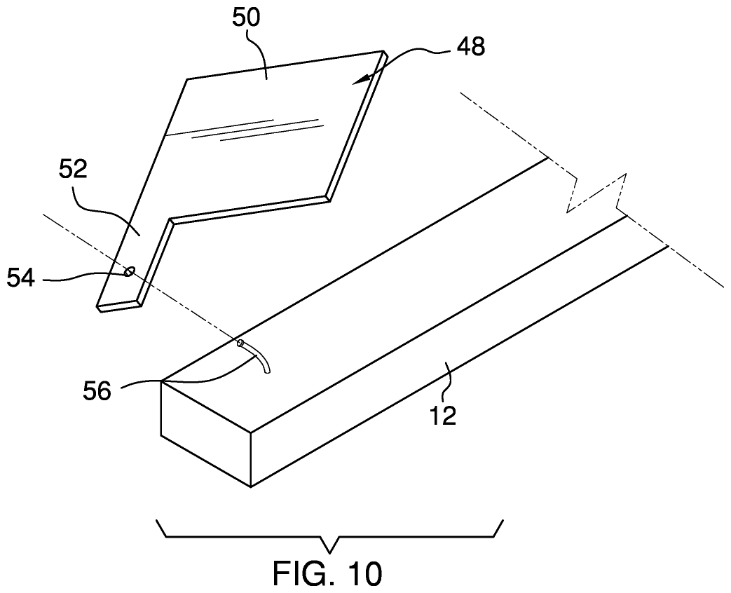

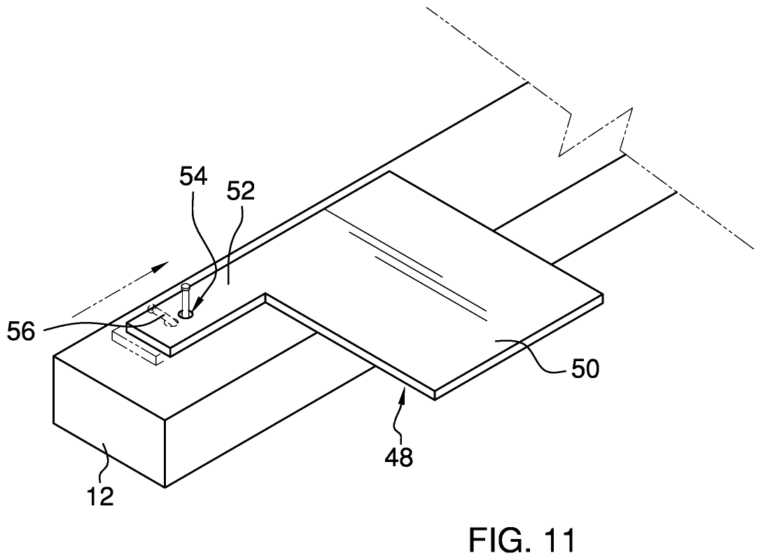

With reference now to the drawings, and in particular to FIGS. 1 through 11 thereof, a new string art kit embodying the principles and concepts of an embodiment of the disclosure and generally designated by the reference numeral 10 will be described.

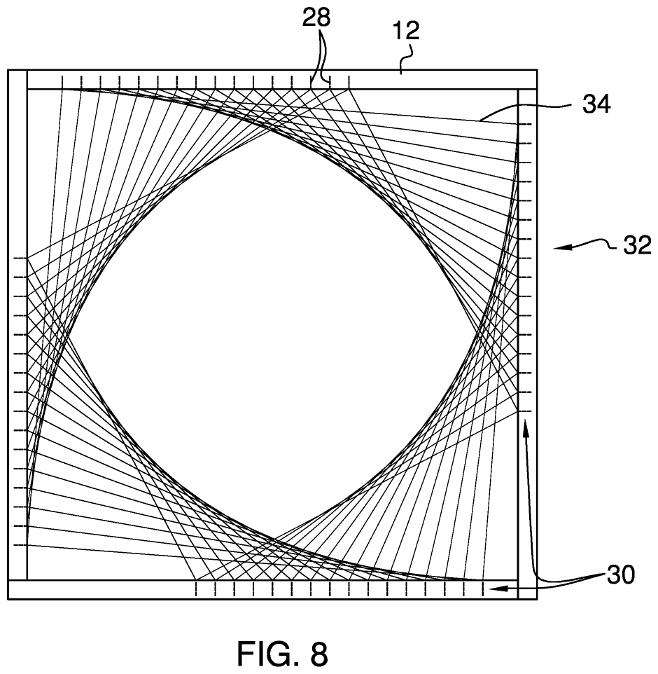

As best illustrated in FIGS. 1 through 11, the string art pattern creation device and method 10 generally comprises a frame 12. For example, the frame 12 may comprise a wooden material. The frame 12 may be rectangular, as shown in FIGS. 1 and 8. In other embodiments, the frame 12 may have an alternative shape, such as circular, cylindrical, or triangular.

A guide board 14 is positionable over the frame 12. The guide board 14 may be rectangular, as shown in the figures, or the guide board 14 may have another shape. The guide board 14 generally has a first end 16 and a second end 18. The guide board 14 may include a notch 20 extending into the first end 16. For example, the notch 20 may be triangular.

A plurality of apertures 22 extends through the guide board 14. The plurality of apertures 22 may be aligned between the first end 16 and the second end 18 of the guide board 14. The plurality of apertures 22 may be centrally positioned on the guide board 14. Each aperture of the plurality of apertures 22 is generally spaced from an adjacent aperture of the plurality of apertures 22, for example by between 0.1 inches and 0.5 inches.

A punch board 24 may have a primary end 42 and a secondary end 44. The punch board 24 may have a width that is less than a width of the guide board 14. The punch board 24 may have a length that is less than a length of the guide board 14.

A guide nail 26 extends through the punch board 24. For example, the guide nail 26 may be positioned adjacent to the primary end 42. The guide nail 26 is configured to facilitate a user in forming a plurality of guide holes 46 in the frame 12. The guide nail 26 is positionable through each aperture of the plurality of apertures 22 wherein the plurality of apertures 22 is configured to facilitate the user in aligning the plurality of guide holes 46 in the frame 12 when the guide board 14 is positioned over the frame 12 and when the punch board 24 is positioned over the guide board 14.

A plurality of nails 28 is insertable into the frame 12 to define a pattern 30 for a string art design 32. The plurality of guide holes 46 is configured to facilitate the user in positioning the plurality of nails 28 centrally within the plurality of apertures 22 extending through the guide board 14 wherein the plurality of guide holes 46 is configured to facilitate the user in inserting the plurality of nails 28 perpendicularly into the frame 12. The plurality of nails 28 extend upwardly from the frame 12 when the plurality of nails 28 are inserted into the frame 12 wherein the plurality of nails 28 is configured to enable the user to wrap string 34 around the plurality of nails 28 according to the pattern 30 thereby forming the string art design 32.

Each nail of the plurality of nails 28 generally includes a head 36 extending outwardly from an elongated body 38. The elongated body 38 generally has a pointed end 40 distal to the head 36. The pointed end 40 is positionable within an associated guide hole of the plurality of guide holes 46 and facilitates the insertion of each nail of the plurality of nails 28 into the frame 12. The head 36 generally has a diameter that is less than a diameter of each aperture of the plurality of apertures 22 extending through the guide board 14 wherein the guide board 14 is removable from the frame 12 when each nail of the plurality of nails 28 is positioned within an associated aperture of the plurality of apertures 22. Each nail of the plurality of nails 28 generally has a size that is smaller than a size of the guide nail 26. Each nail of the plurality of nails 28 generally has a height that is less than a height of the guide board 14, such that the user can hammer the plurality of nails 28 into the frame 12 while the guide board 14 retains the plurality of nails 28 in an upright position within the plurality of guide holes 46.

A handgrip 48 may be engageable with a nail of the plurality of nails 28. For example, the handgrip 48 may engage a crooked nail 56 to facilitate the user in straightening the crooked nail 56 so that the crooked nail 56 extends straight upwardly from the frame 12 and is perpendicular to the frame 12. The handgrip 48 may comprise a plate 50. The plate 50 may be rectangular and planar wherein the plate 50 is configured to facilitate the user in gripping the handgrip 48. An arm 52 may be coupled to and extend outwardly from the plate 50. The arm 52 may be perpendicular to the plate 50. The arm 52 may be coplanar with the plate 50. The arm 52 may be elongated. A through hole 54 may extend through the arm 52. The through hole 54 may be spaced from the plate 50. The through hole 54 may have a diameter that exceeds a diameter of the head 36 of the nail of the plurality of nails 28 wherein the nail is positionable within the through hole 54 to engage the handgrip 48 with the nail of the plurality of nails 28.

In use, the guide board 14 may be positioned over the frame 12. The punch board 24 may be positioned over the guide board 14 such that the guide nail 26 extends through a first aperture of the plurality of apertures 22. The guide nail 26 may be inserted into the frame 12 through the first aperture of the plurality of apertures 22 to form a first guide hole of the plurality of guide holes 46. For example, the guide nail 26 may be hammered into the frame 12 through the first aperture of the plurality of apertures 22. The guide nail 26 may be inserted into the frame to a shallow depth to form each of the plurality of guide holes 46.

The guide nail 26 may be removed from the first aperture of the plurality of apertures 22 once the first guide hole of the plurality of guide holes 46 is formed. Then, the punch board 24 may be positioned over the guide board 14 such that the guide nail 26 extends through a second aperture of the plurality of apertures 22. The guide nail 26 may be hammered into the frame through the second aperture of the plurality of apertures 22 to form a second guide hole of the plurality of guide holes 46. Because the plurality of apertures 22 is aligned along the guide board 14, the second guide hole of the plurality of guide holes 46 is aligned with the first guide hole of the plurality of guide holes 46.

A first nail of the plurality of nails 28 may be placed into the first guide hole of the plurality of guide holes 46 through the first aperture of the plurality of apertures 22. A second nail of the plurality of nails 28 may be placed into the second guide hole of the plurality of guide holes 46 through the second aperture of the plurality of apertures 22. Because the diameter of each aperture of the plurality of apertures 22 exceeds the diameter of the head 36 of each nail of the plurality of nails 28, the guide board 14 may be freely positioned over or removed from the frame 12 while the plurality of nails 28 are inserted into the frame 12.

To insert the first nail and the second nail of the plurality of nails 28 to a uniform height, or depth, within the frame 12, the guide board 14 may be hammered while the first nail and the second nail of the plurality of nails 28 are positioned within the first aperture and the second aperture of the plurality of apertures 22, respectively. The guide board 14 holds each of the first nail and the second nail of the plurality of nails 28 upright to facilitate the user in simultaneously inserting both the first nail and the second nail of the plurality of nails 28 into the frame 12. The guide board 14 thus reduces the amount of time the user needs to spend individually hammering each of the plurality of nails 28 into the frame 12. The guide board 14 also inhibits the plurality of nails 28 from bending while the user hammers the plurality of nails 28 into the frame 12. Once the plurality of nails 28 is inserted into the frame 12, the guide board 14 may each be removed to reveal the pattern 30 of the plurality of nails 28 extending upwardly from the frame 12. The user can then wrap the string 34 around the plurality of nails 28 to form the string art design 32.

If a nail of the plurality of nails is bent during the process, the user may straighten the nail using the handgrip 48. For example, the crooked nail 56 may be inserted into the through hole 54, and the handgrip 48 can be used to pull the crooked nail 56 until the crooked nail 56 is straight and perpendicular to the frame 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A string art nail position guide assembly comprising:
a frame;
a guide board being positionable over the frame;
a plurality of apertures extending through the guide board;
a punch board;
a guide nail extending through the punch board wherein the guide nail is configured to facilitate a user in forming a plurality of guide holes in the frame, the guide nail being positionable through each aperture of the plurality of apertures wherein the plurality of apertures is configured to facilitate the user in aligning the plurality of guide holes in the frame when the guide board is positioned over the frame and when the punch board is positioned over the guide board; and
a plurality of nails being insertable into the frame to define a pattern for a string art design, the plurality of guide holes being configured to facilitate the user in positioning the plurality of nails centrally within the plurality of apertures extending through the guide board wherein the plurality of guide holes is configured to facilitate the user in inserting the plurality of nails perpendicularly into the frame.

2. The string art nail position guide assembly of claim 1, the guide board further comprising a first end, a second end, and a notch extending into the first end.

3. The string art nail position guide assembly of claim 2, wherein the notch is triangular.

4. The string art nail position guide assembly of claim 1, wherein the plurality of apertures is aligned along the guide board.

5. The string art nail position guide assembly of claim 1, wherein the plurality of apertures is centrally positioned on the guide board.

6. The string art nail position guide assembly of claim 1, wherein each aperture of the plurality of apertures is spaced from an adjacent aperture of the plurality of apertures by between 0.1 inches and 0.5 inches.

7. The string art nail position guide assembly of claim 1, wherein the punch board has a width being less than a width of the guide board and wherein the punch board has a length being less than a length of the guide board wherein the punch board is positionable over the guide board wherein the punch board is configured to facilitate the user in hammering the plurality of nails evenly into the frame through the guide board.

8. The string art nail position guide assembly of claim 1, wherein the guide nail is positioned adjacent to a primary end of the punch board wherein the punch board is configured to facilitate the user in holding the guide nail while the user is forming the plurality of guide holes in the frame.

9. The string art nail position guide assembly of claim 1, wherein the plurality of nails extend upwardly from the frame when the plurality of nails are inserted into the frame wherein the plurality of nails is configured to enable the user to wrap string around the plurality of nails according to the pattern thereby forming the string art design.

10. The string art nail position guide assembly of claim 1, each nail of the plurality of nails further comprising a head extending outwardly from an elongated body, the elongated body having a pointed end distal to the head, the pointed end being positionable within an associated guide hole of the plurality of guide holes.

11. The string art nail position guide assembly of claim 10, wherein the head has a diameter being less than a diameter of each aperture of the plurality of apertures extending through the guide board wherein the guide board is removable from the frame when each nail of the plurality of nails is positioned within an associated aperture of the plurality of apertures.

12. A string art nail position guide assembly comprising:
a frame comprising a wooden material;
a guide board being positionable over the frame, the guide board having a first end and a second end, the guide board including:
a notch extending into the first end, the notch being triangular;
a plurality of apertures extending through the guide board, the plurality of apertures being aligned between the first end and the second end of the guide board, the plurality of apertures being centrally positioned on the guide board, each aperture of the plurality of apertures being spaced from an adjacent aperture of the plurality of apertures by between 0.1 inches and 0.5 inches;
a punch board having a primary end and a secondary end, the punch board having a width being less than a width of the guide board, the punch board having a length being less than a length of the guide board;
a guide nail extending through the punch board adjacent to the primary end wherein the guide nail is configured to facilitate a user in forming a plurality of guide holes in the frame, the guide nail being positionable through each aperture of the plurality of apertures wherein the plurality of apertures is configured to facilitate the user in aligning the plurality of guide holes in the frame when the guide board is positioned over the frame and when the punch board is positioned over the guide board;
a plurality of nails being insertable into the frame to define a pattern for a string art design, the plurality of guide holes being configured to facilitate the user in positioning the plurality of nails centrally within the plurality of apertures extending through the guide board wherein the plurality of guide holes is configured to facilitate the user in inserting the plurality of nails perpendicularly into the frame, the plurality of nails extending upwardly from the frame when the plurality of nails are inserted into the frame wherein the plurality of nails is configured to enable the user to wrap string around the plurality of nails according to the pattern thereby forming the string art design, each nail of the plurality of nails being smaller than the guide nail, each nail of the plurality of nails having a height being less than a height of the guide board, each nail of the plurality of nails including:
a head extending outwardly from an elongated body, the elongated body having a pointed end distal to the head, the pointed end being positionable within an associated guide hole of the plurality of guide holes;
the head having a diameter being less than a diameter of each aperture of the plurality of apertures extending through the guide board wherein the guide board is removable from the frame when each nail of the plurality of nails is positioned within an associated aperture of the plurality of apertures;
a handgrip being engageable with a nail of the plurality of nails wherein the handgrip is configured to facilitate the user in straightening the nail within the frame, the handgrip comprising:
a plate, the plate being rectangular wherein the plate is configured to facilitate the user in gripping the handgrip;
an arm being coupled to and extending outwardly from the plate, the arm being coplanar with the plate, the arm being elongated; and
a through hole extending through the arm, the through hole being spaced from the plate, the through hole having a diameter exceeding a diameter of the head of the nail of the plurality of nails wherein the nail is positionable within the through hole to engage the handgrip with the nail.

13. A method of creating a pattern for a string art design, the method comprising:
providing a frame comprising a wooden material;
providing a string art nail position guide assembly being configured to facilitate a user in inserting a plurality of nails into the frame to define a pattern for a string art design, the string art nail position guide assembly comprising:
a guide board being positionable over the frame;
a plurality of apertures extending through the guide board;
a punch board;
a guide nail extending through the punch board wherein the guide nail is configured to facilitate a user in forming a plurality of guide holes in the frame, the guide nail being positionable through each aperture of the plurality of apertures wherein the plurality of apertures is configured to facilitate the user in aligning the plurality of guide holes in the frame when the guide board is positioned over the frame and when the punch board is positioned over the guide board;
a plurality of nails being insertable into the frame to define a pattern for a string art design, the plurality of guide holes being configured to facilitate the user in positioning the plurality of nails centrally within the plurality of apertures extending through the guide board wherein the plurality of guide holes is configured to facilitate the user in inserting the plurality of nails perpendicularly into the frame;
positioning the guide board over the frame;
positioning the punch board over the guide board wherein the guide nail extends through a first aperture of the plurality of apertures;
hammering the guide nail into the frame through the first aperture of the plurality of apertures to form a first guide hole of the plurality of guide holes;
removing the guide nail from the first aperture of the plurality of apertures;
positioning the punch board over the guide board wherein the guide nail extends through a second aperture of the plurality of apertures;
hammering the guide nail into the frame through the second aperture of the plurality of apertures to form a second guide hole of the plurality of guide holes, the second guide hole of the plurality of guide holes being aligned with the first guide hole of the plurality of guide holes;
placing a first nail of the plurality of nails into the first guide hole of the plurality of guide holes through the first aperture of the plurality of apertures;
placing a second nail of the plurality of nails into the second guide hole of the plurality of guide holes through the second aperture of the plurality of apertures;
hammering the first nail and the second nail into the frame through guide board wherein the guide board holds the first nail and the second nail upright and wherein the guide board is configured to facilitate the user in hammering the first nail and the second nail to extend upwardly from the frame to the same height; and
removing the guide board from the frame.

14. The method of claim 13, further comprising:
providing a handgrip being engageable with a nail of the plurality of nails wherein
the handgrip is configured to facilitate the user in straightening the nail within the frame, the handgrip comprising:
a plate, the plate being rectangular wherein the plate is configured to facilitate the user in gripping the handgrip;
an arm being coupled to and extending outwardly from the plate, the arm being coplanar with the plate, the arm being elongated;
a through hole extending through the arm, the through hole being spaced from the plate, the through hole having a diameter exceeding a diameter of the head of the nail of the plurality of nails wherein the nail is positionable within the through hole to engage the handgrip with the nail;
positioning the nail within the through hole; and
pulling the nail with the handgrip to straighten the nail.
